(19) United States
(12) Patent Application Publication
(10) Pub. No.: US 2011/0031120 A1
(43) Pub. Date: Feb. 10, 2011

(54) GEL COMPOSITION

(75) Inventors: Adam Inche, Edinburgh (GB); Helen McNeill, Midlothian (GB); Kenneth Macnamara, Edinburgh (GB)

Correspondence Address: KNOBBE MARTENS OLSON & BEAR LLP, 2040 MAIN STREET, FOURTEENTH FLOOR, IRVINE, CA, 92614, US

(73) Assignee: LAB 901 LIMITED, Lonehead, Midlothian (GB)

(21) Appl. No.: 12/864,344

(22) PCT Filed: Jan. 26, 2009
(86) PCT No.: PCT/GB2009/000219

§ 371 Date: Oct. 19, 2010

(30) Foreign Application Priority Data
Jan. 24, 2008 (GB) 0801321.1

(51) Int. Cl. G01N 27/447

(52) U.S. Cl. 204/455; 204/469; 204/470; 204/466; 204/461; 204/606

(57) ABSTRACT

A gel composition for use in electrophoresis analysis of proteins, characterised in that the gel composition includes a polar solvent as an additive, wherein the polar solvent is one of either an alcohol or a formamide derivative. Methods of use, methods of manufacture and apparatus including the gel composition described hereinabove are also provided.

The present invention relates to a gel composition for use in electrophoresis analysis of proteins.

Polyacrylamide gel electrophoresis is a commonly used technique for protein analysis. Denatured proteins are introduced into a porous gel matrix and separated on the basis of their mobility through the gel when placed in an electric current. The mobility within the gel matrix is related to the charge and mass of the protein molecule. Normally proteins do not have a fixed mass to charge ratio, as the charge can be affected by the composition and conformation of the protein molecule. In order to allow the proteins in a different sample to attain a fixed mass to charge ratio, the proteins are denatured to remove their tertiary structure and the surfactant dodecyl sulphate is added to coat the molecules uniformly with negative charge. The proteins move through the gel at a speed related to their size, so that smaller proteins migrate more quickly than larger proteins. When the electrical current is stopped, the bands of protein molecules can be analysed using, for example, fluorescence or Western blot analysis. Thus, proteins can be separated and analysed in a polyacrylamide matrix on the basis of size, using electrophoresis, also known as ‘molecular sieving’.

The molecular weight range of the proteins which can be separated, or the linear range of separation of a gel is related to the percentage concentration of polyacrylamide in a given gel matrix. Acrylamide polymerises in such a way that pores form within the gel that enable the ‘molecular sieving’ effect. At low polyacrylamide percentages, larger molecular weight proteins are separated and resolved well with poor separation and resolution of the lower molecular weight species. Conversely, high polyacrylamide percentages are effective at separating and resolving low molecular weight proteins, but the separation and resolution of higher molecular weight proteins is poor. The separation range of a gel can be visualised by plotting the Logarithm of molecular weight (Log MWt) versus the distance of migration. The separation range of a given gel will fall within the linear range of the sigmoidal curve. Out of this linear range, the proteins are either too large to enter the gel matrix, and thus do not migrate, or are too small to be sieved by the matrix and migrate together as if in free solution.

The user must therefore select a gel with an appropriate percentage of polyacrylamide for the molecular weight of the proteins in the sample to be tested. For example, a 12% polyacrylamide gel may be selected for proteins in the molecular weight range 10-100 kDa, while a 7.5% polyacrylamide gel may be selected for the separation of proteins in the molecular weight range of 40-250 kDa (http://www.bio.davidson.edu/people/jowilliamson/Techniques/Protocolweek11.html). If the sizes of the protein molecules are not known, then selecting the correct gel is difficult. This can lead to wasted gels and samples and loss of productivity, as the results of the electrophoresis separation may not be resolved sufficiently for the purpose of analysis, and experiments may have to be repeated as a result. In particular, proteins of very high or very low molecular weight in a sample may not be detected due to poor separation and/or resolution. The user may also have to run several experiments on gels of different polyacrylamide percentages in order to determine which is the correct one to use for a particular sample.

A common method to extend the linear range of separation is to form a so-called gradient gel. These gels are cast in such a way as to have increasing percentages of polyacrylamide, and therefore decreasing pore size, at increasing migration distances. This allows large proteins to enter the matrix at lower polyacrylamide percentages whilst smaller proteins are effectively sieved at higher polyacrylamide percentages. Producing a gradient gel can be time-consuming and complicated, requiring careful mixing of different solutions containing different polyacrylamide concentrations, and additionally may require the use of catalysts and radiation to ensure that a required pore size gradient is achieved. Therefore, especially in the case of capillary electrophoresis when the scale is very small, gradient gels are time consuming, inconvenient and expensive to produce.

US Patent Application Publication No. 2006/0021876 describes the use of DMSO as an additive to improve the resolution of lower molecular weight bands. However, it does not demonstrate improved resolution of higher molecular weight bands. In order to achieve improved resolution of bands of a wider range of molecular weights, standard practice for the person skilled in the art is to use a gradient gel. As discussed hereinabove, there are disadvantageous for a number of cost and efficiency-related reasons. A need remains for a polyacrylamide gel matrix that can be used in capillary or slab gel electrophoresis, and which has an improved linear range of separation, including enhanced separation and resolution of both higher and lower molecular weight proteins.

The use of solvents in CEC (capillary electrophoresis chromatography) and CZE (capillary zone electrophoresis) is known in the prior art. These solvent additives are generally referred to as organic modifiers. Huie et al (Electrophoresis 2003 May; 24(10):1508-29) and Li et al (Electrophoresis 2005 September; 26(17):3349-59) are representative publications which utilise organic modifiers in the separation of small molecules. These papers, as well as the US Patent Application Publication No. 2006/0021876 discussed above, use organic modifiers to alter electroosmotic flow (EOF) in capillaries where the surface walls are fused silica or linear polymeric dimethyl acrylamide and the separation matrices are uncross-linked linear polymers. The regulation of the EOF improves resolution by reducing band diffusion. In the invention of the present application, using a cross-linked polyacrylamide gel EOF is not of primary consideration and the addition of alcohols, formamide or formamide derivatives alters the separation profile of the lower molecular weight protein bands to improve resolution.

It is an object of the present invention to provide compositions, additives, methods and apparatus that seek to mitigate one or more of the above-mentioned disadvantages.

According to one aspect of the invention there is provided a gel composition for use in electrophoresis analysis of proteins, characterised in that the gel composition includes a polar solvent, wherein the polar solvent comprises an alcohol, formamide or a formamide derivative. The advantage of a composition containing such an additive is that a wider range of protein sizes can be resolved without requiring a gradient gel that is inconvenient and time-consuming to produce.

Preferably the gel composition has a separation range of 200-5 kDa, providing a single gel on which a large number of differently sized proteins may be resolved

It is preferred that the polar solvent has distinct regions of polarity and non-polarity.

The polar solvent may be an alcohol selected from isopropanol, methanol, ethanol and hexanediol. Most preferably, the alcohol is isopropanol.

The formamide derivative may be selected from acetonitrile, dioxane, dimethylformamide, diethylformamide and dimethylsulphone. Most preferably, the formamide derivative is diethylformamide. Diethylformamide at a 5% (v/v) concentration added to both the polyacrylamide matrix and the running buffer has been shown to be optimal, however the range of 2-10% (v/v) concentration has been tested with significant improvements in separation.

The gel may have a uniform polyacrylamide concentration. Such electrophoresis gel compositions of the invention are convenient and cost-effective to produce, especially in comparison to gradient gels. This is particularly true for capillary electrophoresis purposes, in which the gel channel is of microfluidic proportions. In this case, it is difficult to produce a gradient gel due to the small scale.

As an alternative, the gel may have a variable polyacrylamide concentration. The use of polar solvents as additives in a gradient gel has been shown to improve the resolution of a wide range of molecular weight bands.

According to a second aspect of the invention, there is provided the use of a polar solvent as an additive in the manufacture of a gel composition.

According to a third aspect of the invention, there is provided a method of gel electrophoresis, comprising providing a portion of a gel composition as set out hereinabove, providing a sample, applying the sample to the gel composition, applying an electrical current to gel composition for a predetermined period of time and detecting and analysing the separated proteins in the gel composition. This method of electrophoresis is advantageous over the prior art because a sample with proteins of a large variety of different molecular weights can be separated in one experiment, increasing efficiency and cost-effectiveness. Furthermore, the resolution of proteins of different molecular weights is improved so that the accuracy of size determination for individual protein bands is improved.

The separated proteins may be analysed directly, for example but not limited to fluorescence, or the separated proteins may be analysed indirectly using, for example, Western blotting.

According to a fourth aspect of the invention there is provided a capillary electrophoresis unit including a gel composition as set out hereinabove. It is unusually difficult to pour a gradient gel for use in a capillary electrophoresis apparatus. This is because the small scale of the apparatus further complicates the already complex task of ensuring that an effective gradient of pore sizes is produced during polymerisation of the gel. The use of a uniform concentration polyacrylamide gel with a larger linear range of separation therefore improves the ease of use and convenience to the user of a capillary gel electrophoresis apparatus.

According to a fifth aspect of the invention there is provided a slab gel unit, including a gel composition as set out hereinabove. Slab gels have a wide range of uses, but the limitations of uniform polyacrylamide gels, and also of gradient gels are, as discussed hereinabove, disadvantageous. It is particularly advantageous to have a slab gel with an increased linear range of separation because the user is able to use one gel for a single experiment.

According to a fifth aspect of the invention, there is provided a method of manufacturing a gel composition as hereinabove described, comprising providing polyacrylamide gel ingredients and a polar solvent, mixing the ingredients in solvent until a solution is formed, pouring the mixture into a mould device and allowing the gel composition to set or polymerise. This method is advantageous over the prior art because it provides a gel with a wider linear range of separation than other gels of uniform polyacrylamide concentration, but it does not involve a complex and lengthy pouring and/or setting procedure as would be required for the production of a gradient gel. This method of manufacturing a gel therefore provides the advantages that can be provided by the gradient gel, but without the inconvenience, time and money spent on producing the latter.

According to a fifth aspect of the invention, there is provided a gel electrophoresis apparatus comprising a gel composition as described hereinabove.

It is preferred that the apparatus comprises a plastics material, in which is formed at least one volume for containing the gel composition.

A wide linear range of separation is desirable for the usefulness of small scale electrophoresis apparatus such as capillary and other microfluidic devices. This has been a complex problem to solve, because of the difficulties outlined hereinabove in producing a gradient gel on a sufficiently small scale. Producing a uniform polyacrylamide gel that, nevertheless, has a wide range of separation is an unexpected solution and the gels are simpler, more efficient, and cost effective to produce. The provision of an apparatus in which a gel with a wide linear range of separation is incorporated is useful to the user in a number of ways. The user does not need to run multiple experiments in order to select the appropriate gel, because the gel has a sufficient range of separation and resolution power for a wide range of protein sizes. Furthermore, the user does not need to pour the gel, because it is already provided within the apparatus on supply.

An embodiment of the invention will now be described by way of example with reference to the accompanying figures, in which:

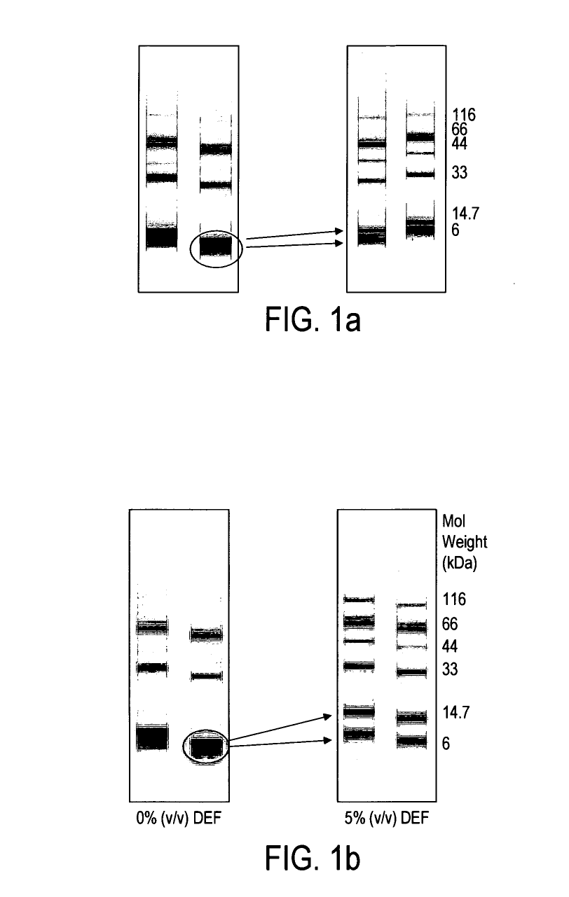

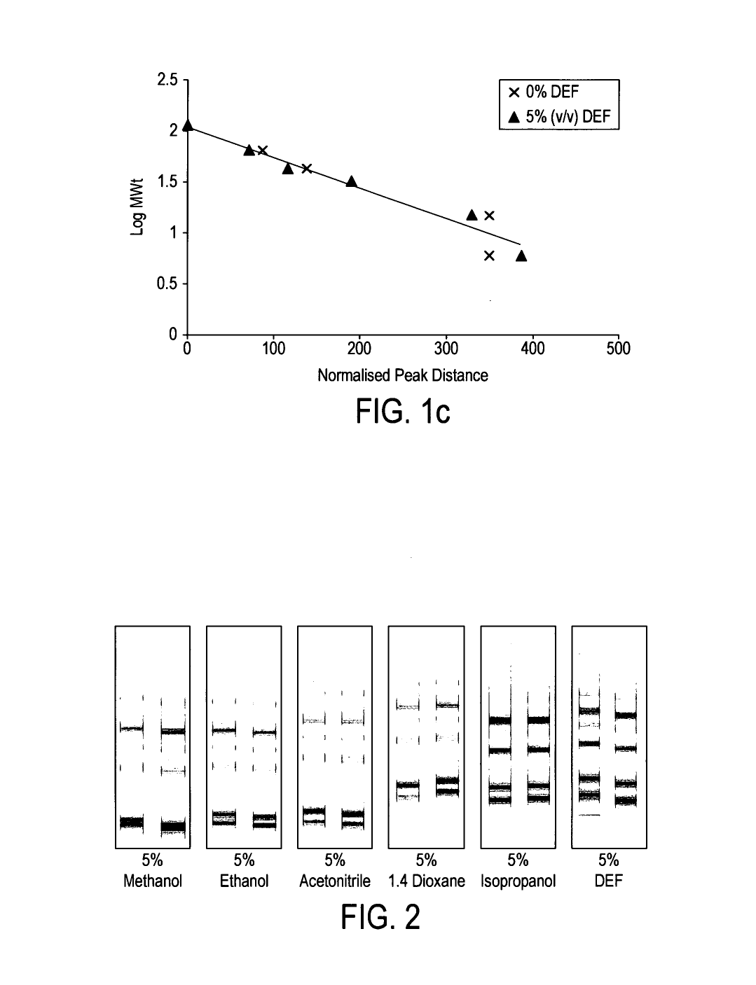

FIG. 1a is an image of the separation profiles of two polyacrylamide gels, one with 5% (v/v) dimethylformamide added and one with 0% dimethylformamide.

FIG. 1b is an image of the separation profiles of two polyacrylamide gels, one with 5% (v/v) diethylformamide added and one with 0% diethylformamide.

FIG. 1c is a plot of Log molecular weight (Log MWt) versus the normalised band peak distance, showing data measured from two polyacrylamide gels, one with 5% (v/v) diethylformamide added and one with 0% diethylformamide.

FIG. 2 is a series of gel separation profiles, showing a comparison between solvent free gels and gels containing 5% (v/v) different polar solvents.

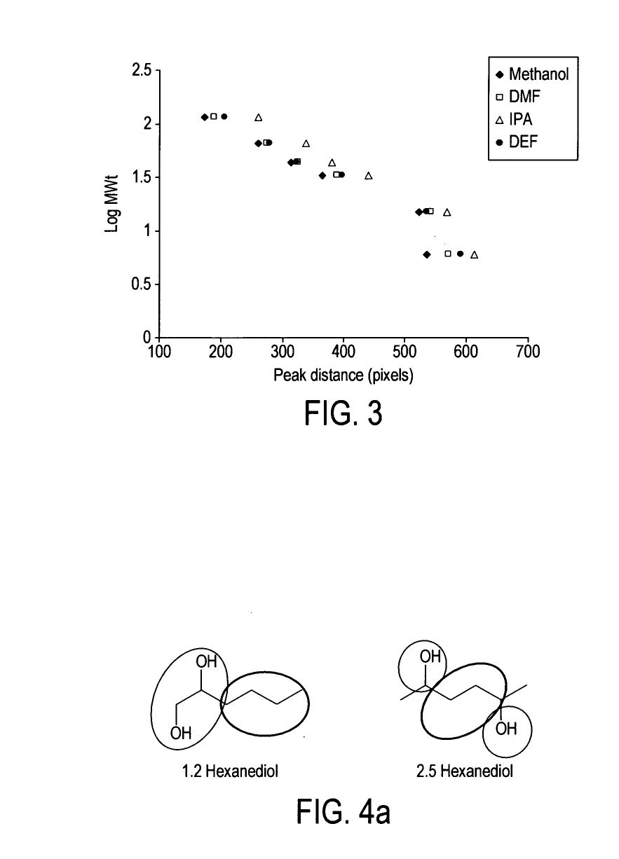

FIG. 3 is a graph showing the peak distance vs Log molecular weight, showing the data from gels containing 5% v/v methanol, DEF, IPA and DMF.

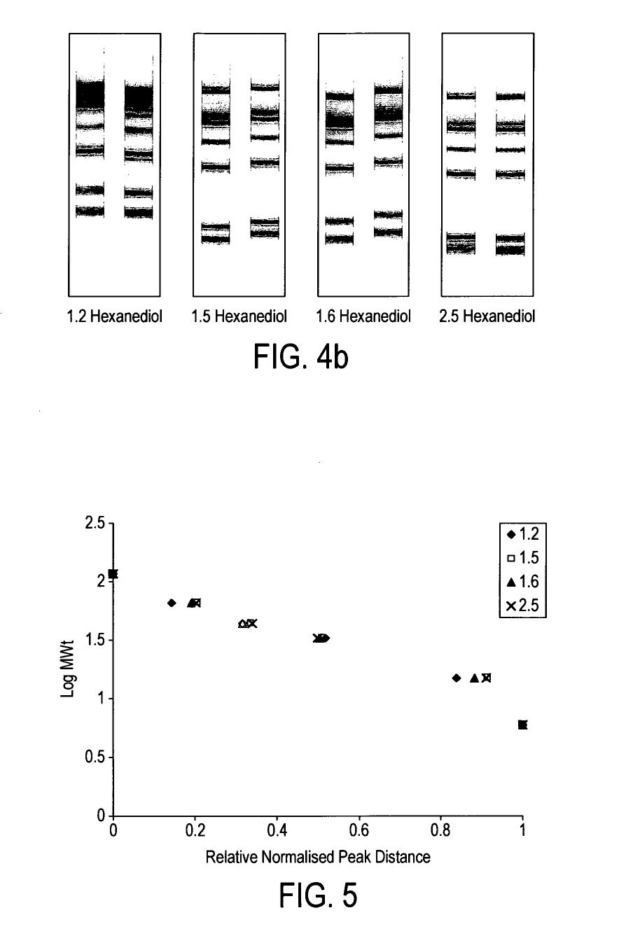

FIG. 4a is a schematic representation showing the distinction between polar and non-polar regions for 1,2 hexanediol and 2,5 hexanediol.

FIG. 4b is an image of the separation profiles of four polyacrylamide gels, with 5% (v/v) of 1,2; 1.5; 1.6 and 2.5 hexanediol.

FIG. 5 is a graph showing relative normalised peak distance versus Log MWt for 200 mM Hexanediol Isoforms

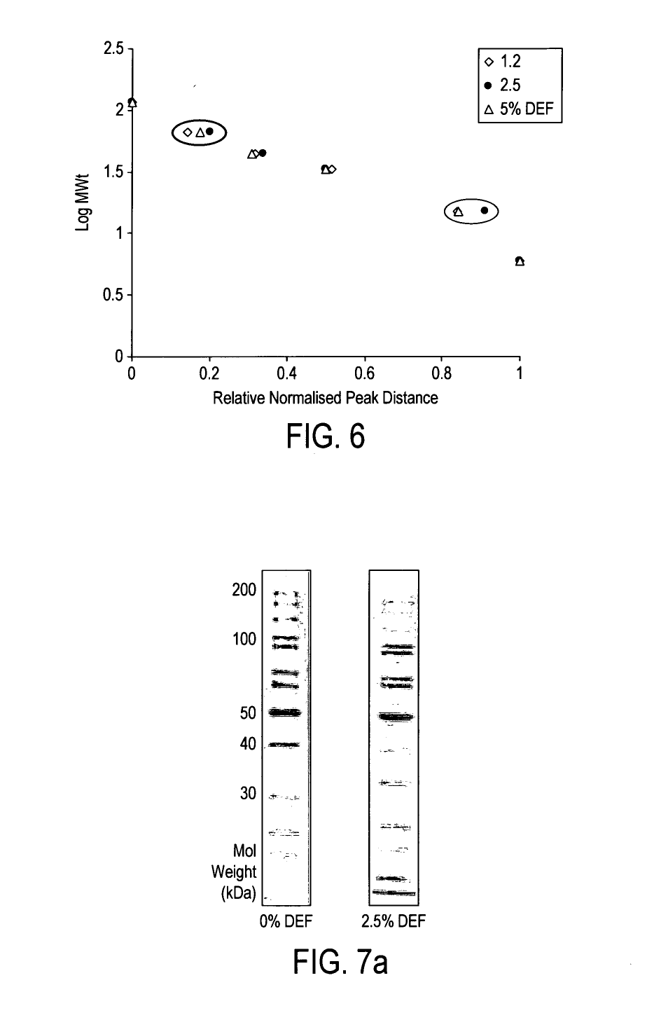

FIG. 6 is a graph showing the relative normalised peak distance versus Log MWt for Hexanediol and DEF

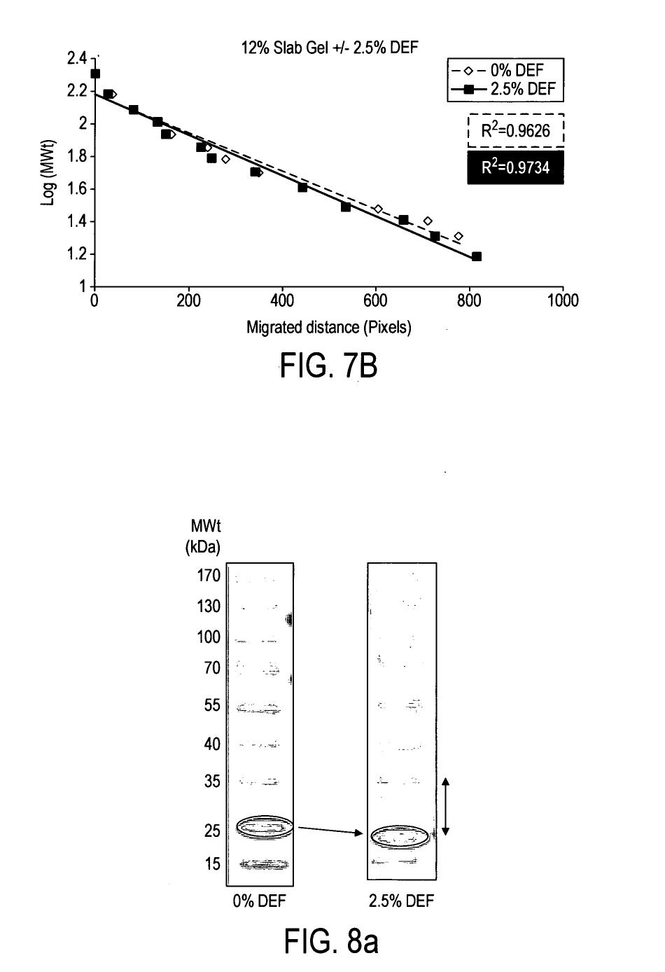

FIG. 7A is an image showing the separation profiles of two polyacrylamide slab gels, one with 2.5% (v/v) diethylformamide added and one with 0% diethylformamide.

FIG. 7B is a plot of Log molecular weight (Log MWt) versus the normalised band peak distance, showing data measured from two polyacrylamide slab gels, one with 2.5% diethylformamide (v/v) added and one with 0% diethylformamide.

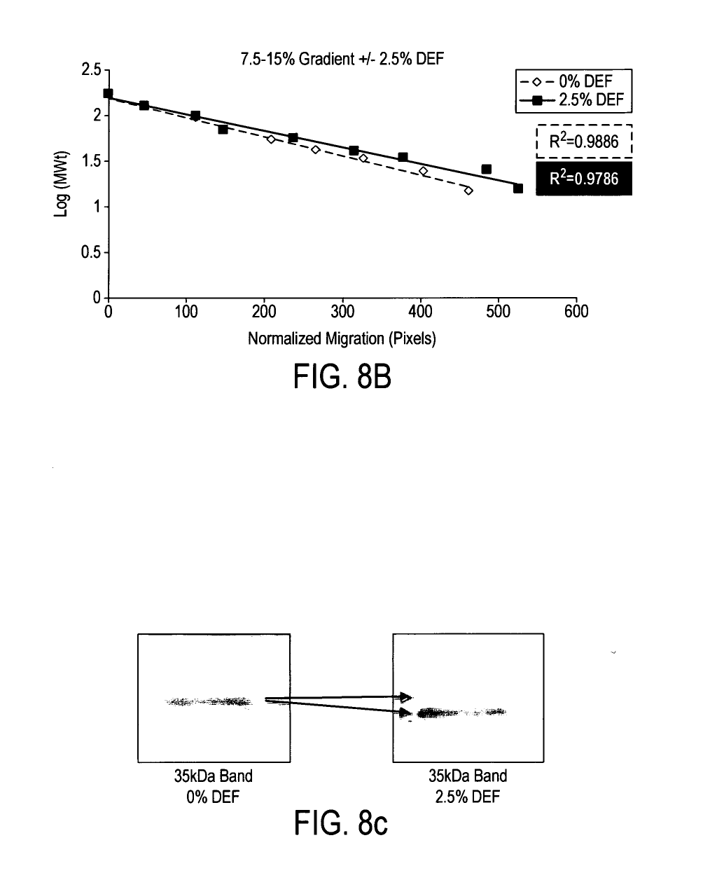

FIG. 8a is an image of the separation profiles of two 7.5-15% gradient polyacrylamide slab gels, one with 2.5% (v/v) diethylformamide added and one with 0% diethylformamide.

FIG. 8b is a plot of Log molecular weight (Log MWt) versus the normalised band peak distance, showing data measured from two 7.5-15% gradient polyacrylamide slab gels, one with 2.5% (v/v) diethylformamide added and one with 0% diethylformamide.

FIG. 8c is an enlarged image of the 35 kDa band from part a of this figure.

### EXAMPLE 1

### Manufacturing a Gel for Use with Polar Solvents

The alcohol or formamide derivative may be added to a standard Laemmli SDS-PAGE system, or the Applicant's ScreenTape® system to the same effect of increasing the resolution of the smaller protein bands. Acrylamide and crosslinker (e.g. N,N′-methylenebisacrylamide) were added to a buffer containing 375 mM TrisHCl pH 8.8, 0.1% (w/v) SDS, 0.05% (w/v) ammonium persulphate and 0.07% (v/v) TEMED. The final concentration of acrylamide typically ranged from 7% to 15% (w/v), the crosslinker typically varied according to acrylamide concentration from 0.19% to 0.25% (w/v) N,N′-methylenebisacrylamide. The appropriate alcohol or formaldehyde derivative was added to the acrylamide mixture to the appropriate concentration that was typically below 5% (v/v). The gel was then poured and allowed to polymerise at room temperature. The chosen alcohol or formamide derivative was added to the same concentration as added to the gel matrix to any additional component of the separation matrix (e.g. stacking gel) as required. A gradient gel matrix was cast using the above constituent ingredients together with the addition of sucrose. A two chamber gradient mixing unit was used to mix the “heavy” bottom gel mixture together with the “light” top gel mixture. The “light” gel consisted of 7.5% (w/v) acrylamide, 0.09% (w/v) N,N′-methylenebisacrylamide, 87 mM sucrose together with the chosen alcohol or formaldehyde derivative to typically below 5% (v/v) and the other constituents listed above. The heavy gel consisted of 15% (w/v) acrylamide, 0.18% (w/v) N,N′-methylenebisacrylamide, 174 mM sucrose together with the chosen alcohol or formaldehyde derivative to typically below 5% (v/v) and the other constituents listed above. The running buffer for all of the above mentioned polyacrylamide gels was 25 mM TrisHCl, 200 mM glycine, 0.1% (w/v) SDS together with the appropriate alcohol or formaldehyde derivative to the same concentration as present in the polyacrylamide matrix. The SDS-PAGE with the alcohol or formaldehyde derivative is run and analysed in the same mariner as a standard SDS-PAGE system.

The ScreenTape® system is similar in concept to the SDS-PAGE system. Typically higher concentrations of the chosen alcohol or formaldehyde derivative are used, these being around 5% (v/v), but may be up to 10% (v/v).

### EXAMPLE 2

### Investigation of the Effect of Diethylformamide on Resolving Properties of a Gel

The preferred formulation at the initiation of this investigation for the gels included Dimethylformamide (DMF). It had been noted that these gels did not retain any separation of the bottom bands, in a similar fashion to no DMF being present in the gels. Patents exist on the use of DMSO as an additive for capillary electrophoresis (CE) to aid in the resolution of the lower bands, which initially led to the addition of DMF. Although not presented here, some investigation was done into the comparison of DMSO versus DMF; DMF proved a better additive. However, no systematic study was carried out into other possible additives that might replicate or improve on the current separation of proteins below 20 kDa obtained with DMF. Of greater importance was to seek an alternative to DMF that would persist within the gel (and system) and allow separation below 20 kDa.

FIG. 1a below shows the comparison between a gel without DMF (i.e. solvent free) to a gel that has 5% solvent. In this figure, the solvent free gel (left) is compared to a gel containing 5% DMF (right). Gels are run with a protein standard ladder with the corresponding masses of the bands indicated in kDa on the far right. The red oval indicates the lower bands in the solvent free gel. It can be seen that the performance of the gel overall is better (bands are sharper) with DMF, however, the system was optimised with DMF as a component. The focus of this study is the bottom bands at 14.7 and 6 kDa, so the sharpness of the bands will not be analysed at this time.

FIG. 1b) shows that two bands that cannot be separated without any solvent additive are separated with the addition of diethylformamide. FIG. 1c shows that the addition of 5% (v/v) diethylformamide (purple circles) brings the last two peaks (14.7 and 6 kDa) closer to the linear range than the dimethylformamide-free gel formulation (blue diamonds).

### EXAMPLE 3

### Investigation of the Effect of Various Polar Solvents on the Resolving Abilities of the Gel

Various percentages (v/v) of polar solvents were analysed by replacing the standard 5% DMF with increasing percentage concentrations of the common polar solvents Methanol, Ethanol, Acetonitrile, 1,4 Dioxane, Propan-2-ol, as well as the non-toxic Diethylformamide. Representative lanes from these experiments are shown in FIG. 2. The 5% ratio of solvent proved to be the indicative of overall performance. Presented in FIG. 2 are the profiles for all the solvents tested in this study. It is worth noting at this time that certain solvents facilitated faster migration with methanol facilitating the fastest migration.

It can be seen from FIG. 2 that the separation profiles are altered depending upon the solvent added. From this figure it can be said that 5% Methanol performs poorly compared to Isopropanol or DEF. There is also a degree of compression between the upper 116 kDa band and the lower 6 kDa band with these two additives. To make a more formal assessment of performance a graph was plotted of Log Molecular weight versus migration distance. FIG. 3 shows peak distances in pixels plotted against Log of molecular weight in kDa for four polar solvents. The peaks for 5% Methanol, DMF, IPA and DEF are plotted in blue, purple, yellow and orange respectively. The R squared value for straight lines (lines omitted for clarity) are indicated in the respective colours for the additives. FIG. 3 therefore shows that the addition of 5% DEF brings the distribution of the peaks towards linearity, as the R squared value for DEF is the closest to 1. From this analysis DEF is the best performing solvent together with Isopropanol (TA) achieving a more linear profile than DMF.

### EXAMPLE 4

### Investigation of the Effect of Distinct Regions of Polarity on the Effect of the Polar Solvent in Improving Resolution of the Gel

The additives appear to be important for the separation of a wide range (200-6 kDa) of proteins that is normally only achieved by the formation of a percentage gel system. It is believed that the alcohol or formamide derivative additives affect the linear range by assisting dodecyl sulphate in denaturing the proteins. (i.e. perfectly denatured species are assumed to lie on a straight line on a graph similar to FIG. 3). By analysing the different peak separation profiles for hexanediol isoforms it is proposed that clear distinctions between aliphatic (or non-polar), and polar regions of the solvent molecule is essential for its mode of action in promoting an extension of the linear range. In an attempt to answer this hypothesis a comparison of peak distributions using Hexanediol isoforms was performed. It was reasoned that in a similar mechanism to detergents, the solvents required polar and non-polar regions. It was thus predicted that 1,2 Hexanediol which has a distinct polar and aliphatic regions would perform better than 2,5 Hexanediol where the polar/aliphatic regions are less well defined (FIG. 4a).

To test the hypothesis, 200 mM of the Hexanediol isoform was included into the geland buffer. FIG. 4b shows the profiles for the four hexanediol isoforms used and show that the addition of 1,2 hexanediol to a gel composition, a molecule with definite polar and non-polar regions, increases separation and resolution of proteins when compared with than 2,5 hexanediol, the molecules of which has a less well-defined distinction between polar and non-polar regions.

It can be seen that 1,2 and 1,6 Hexanediol alter the profile and increase the separation between the 14.7 kDa and the 6 kDa bands. The graph of position versus log MWt (not shown) indicated that 1,2 and 1,6 Hexanediol had a more “linear” profile. To eliminate the possibility that this linearity was due to compression of the profile, the ratios of the peak distance to the final peak was plotted (FIG. 5). FIG. 5 is a plot of the peak distance relative to the final peak. The peak distances were initially normalised to the first peak (116 kDa). The hexanediol isoforms are represented as 1,2; 1,5; 1,6 and 2,5. The 66 kDa and the 14.7 kDa peak are indicated by red and blue circles respectively. This showed that the 14.7 kDa peak did shift relative to the 6 kDa peak for 1,2 Hexanediol. It can also be seen that the 66 kDa peak with this isoform was also shifted more relative to the other isoforms.

Thus as hypothesised the isoform with the most distinct regions of polar versus non-polar, 1,2 Hexanediol, has a larger effect on the separation profile then the isoforms with less distinctly defined regions. Other factors may be contributing towards separation with the addition of these solvents. For example, the solvents may be assisting in the formation of a more even acrylamide gel matrix.

### EXAMPLE 5

### Performance of DEF Compared to Other Polar Solvents in Improving Resolution Capabilities of the Gels

Overall the performance of DEF has been judged to be the best as Log MWt vs Distance plots had the best R squared values for the straight line. In a similar graph to FIG. 5, the performance of DEF can be compared to the 1,2 hexanediol and 2,5 hexanediol as the best and worst performing isofoms of Hexanediol with respect to separation (FIG. 6). FIG. 6 is a plot of the peak distance relative to the final peak. The peak distances were initially normalised to the first peak (116 kDa). The hexanediol isoforms are represented as 1,2 and 2,5 respectively. Red and blue circles indicate the 66 kDa and the 14.7 kDa peak respectively. It can be seen that the 14.7 kDa peak is shifted a similar amount in DEF compared to 1,2 Hexanediol. The 66 kDa peak is not shifted as significantly with the addition of DEF.

### EXAMPLE 6

### Effect of Polar Solvents in Improving Resolving Abilities of Slab Gels

The additives have the same affect in slab gel electrophoresis. To investigate how DEF affects the performance of slab gels a comparison of a 12% acrylamide gel containing 2.5% DEF both in gel and running buffer was made with the same gel lacking DEF. FIG. 7a shows a Coomassie stained SDS-PAGE of PageRuler Ladder (Fermentas) with 0% and 2.5% DEF in gel and buffer, and demonstrates the effect of 2.5% (v/v) diethylformamide on separation and resolution of proteins in a polyacrylamide slab gel (right), by comparing the separation profile with that of gel with 0% diethylformamide (left). In a plot of Log molecular weight (Log MWt) versus the normalised band peak distance in FIG. 7b, a plot of log molecular weight versus migrated distance for ladder in part a. R squared values for the lines are highlighted in the same colour as the DEF concentrations, it can be seen that the separation and resolution of the lower molecular weight proteins was enhanced significantly, in a similar manner to the increased linear range of protein separation, as discussed hereinabove, which was observed in the gels within the Lab901 ScreenTape®. The maximal relative shift of a protein band is very significant at 12% for the 30 kDa band. In other words, the data shows that there is an effect of DEF on the performance of the gel, and that the proteins migrate closer to the “ideal” linearity of separation.

An assessment has also been made on the affect of the addition of 2.5% (v/v) diethylformamide to a 7.5-15% gradient polyacrylamide slab gel. FIG. 8a, a Coomassie stained SDS-PAGE of PageRuler Prestained Ladder (Fermentas) with 0% and 2.5% DEF in gel and buffer, demonstrates the effect of 2.5% (v/v) diethylformamide on separation and resolution of proteins in a 7.5-15% gradient polyacrylamide slab gel (right), by comparing the separation profile with that of a 7.5-15% gradient gel with 0% diethylformamide (left). The circle shows the effect of the addition of 2.5% (v/v) diethylformamide on the migration of the 25 kDa band.

In a plot of Log molecular weight (Log MWt) versus the normalised band peak distance in FIG. 8b, R squared values for the lines are highlighted in the same colour as the DEF concentrations. This figure shows that the addition of diethylformamide to a 7.5-15% gradient gel system does not contribute to an overall increase in resolution. FIG. 8c is a zoomed image of the 35 kDa band in part a and demonstrates that the resolution of the lower portion of the gel was greatly enhanced, as the 35 kDa band was able to be resolved into two distinct bands the presence of 2.5% (v/v) diethylformamide.

1. A gel composition for use in electrophoresis analysis of proteins, characterised in that the gel composition includes a polar solvent, wherein the polar solvent comprises an alcohol, formamide or a formamide derivative.

2. A gel composition according to claim 1, wherein the gel has a range of separation of 200-6 kDa.

3. A gel composition according to claim 1, wherein the polar solvent has regions of polarity and non-polarity.

4. A gel composition according to claim 1, wherein the polar solvent is an alcohol selected from isopropanol, methanol, ethanol and hexanediol.

5. A gel composition according to claim 4, wherein the alcohol derivative is isopropanol.

6. A gel composition according to claim 1, wherein the polar solvent is a formamide derivative selected from acetonitrile, dioxane, dimethylformamide, diethylformamide and dimethylsulphone.

7. A gel composition according to claim 6, wherein the formamide derivative is diethylformamide.

8. A gel composition according to claim 1, wherein the gel has a uniform polyacrylamide concentration.

9. A gel composition according to claim 1, wherein the gel has a variable polyacrylamide concentration.

10. A method of manufacturing the gel composition of claim 1, comprising using the polar solvent as an additive in the manufacture of a gel composition.

11. The method of manufacturing the gel composition according to claim 10, wherein the polar solvent is an alcohol derivative or a formamide derivative.

12. The method of manufacturing the composition according to claim 10 wherein the polar solvent has regions of polarity and non-polarity.

13. The method of manufacturing the gel composition according to claim 10 wherein the polar solvent is an alcohol derivative and is selected from isopropanol, methanol, ethanol and hexanediol.

14. The method of manufacturing the gel composition according to claim 13 wherein the polar solvent is isopropanol.

15. The method of manufacturing the gel composition according to claim 10 wherein the polar solvent is a formamide derivative and is selected from acetonitrile, dioxane, dimethylformamide, diethylformamide and dimethylsulphone.

16. The method of manufacturing the gel composition according to claim 15 wherein the formamide derivative is diethylformamide.

17. A method of gel electrophoresis, comprising:
providing a gel composition as defined in claim 1;
providing a sample;
applying the sample to the gel composition;
applying an electrical current to the gel composition for a predetermined period of time; and
detecting and analysing separated proteins in the gel composition.

18. A method according to claim 17, wherein the gel composition is contained within a capillary electrophoresis unit.

19. A method according to claim 17, wherein the gel composition is configured into a slab gel.

20. A method according to claim 17, wherein protein bands are analysed directly using fluorescence.

21. A method according to claim 17, wherein protein bands are analysed indirectly using Western blot analysis.

22. A method of manufacturing a gel composition according to claim 1, comprising;
providing polyacrylamide gel ingredients and a polar solvent,
mixing said ingredients in a solvent;
heating the mixture until the ingredients dissolve to produce a solution;
pouring the mixture into a mould device; and
allowing the gel composition to set.

23. A method according to claim 22, wherein the polar solvent is one of either a formamide or an alcohol derivative.

24. A method according to claim 22, wherein the polar solvent has regions of polarity and non-polarity.

25. A method according to claim 22, wherein the polar solvent is an alcohol and is selected from isopropanol, methanol, ethanol and hexanediol.

26. A method according to claim 25, wherein the alcohol is isopropanol.

27. A method according to claim 22, wherein the polar solvent is a formamide derivative and is selected from dimethylformamide, diethylformamide and dimethylsulphone.

28. A method according to claim 27, wherein the formamide derivative is diethylformamide.

29. A method according to claim 22, wherein the gel has a variable polyacrylamide concentration.

30. A method according to claim 22, wherein the gel has a uniform polyacrylamide concentration.

31. A gel electrophoresis apparatus comprising: a gel composition as defined in claim 1.
